(19) United States
(12) Patent Application Publication
(10) Pub. No.: US 2007/0283373 A1
(43) Pub. Date: Dec. 6, 2007

(54) Positioning Apparatus of Guide Rod for Optical Disk Drive

(75) Inventor: Min-Cheng Yang, Hsinchu (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: LITE-ON IT CORPORATION, Taipei City (TW)

(21) Appl. No.: 11/532,139

(22) Filed: Sep. 15, 2006

(30) Foreign Application Priority Data
Jun. 2, 2006 (TW) 95119659

(51) Int. Cl. G11B 7/00

(52) U.S. Cl. 720/677

(57) ABSTRACT

The present invention discloses a positioning apparatus of guide rod for an optical disk drive. The positioning apparatus includes at least a guide rod for supporting an optical pickup head, a chassis and a spindle plate for supporting a spindle motor. One end of the guide rod is disposed on the chassis and the other end is disposed on the spindle plate. According to the present invention, the accumulating tolerance produced by the assembling is reduced, and the off-center distance between the spindle motor and the laser beam emitted from the optical pickup head is controlled within the precision range. Therefore the reading accuracy and efficiency of the optical pickup head are improved.

### FIELD OF THE INVENTION

The present invention relates to a positioning apparatus of guide rod for an optical disk drive, and more particularly to a positioning apparatus of guide rod that reduces the accumulating tolerance produced by the assembling.

### BACKGROUND OF THE INVENTION

The optical disk drive is widely used nowadays. The optical disk is developed to contain more and more data than before. In order to read the data on the optical disk containing more and more data, the reading accuracy of an optical pickup head in the optical disk drive must make progress to catch up with the rapid development of the optical disk.

Please refer to FIG. 1. FIG. 1 is a partially exploded view of internal mechanism of a conventional optical disk drive.

The internal mechanism of the conventional optical disk drive includes a chassis 1 for supporting two guide rods. The two guide rods include a first guide rod 2 and a second guide rod 3. An optical pickup head 5 is slidably disposed on the first guide rod 2 and the second guide rod 3 and moved on the two guide rods by a stepping motor mounted on the chassis 1 so as to read an optical disk. Further, a spindle plate 6 for supporting a spindle motor 4 which is used to support and rotate the optical disk is disposed on the chassis 1.

Please refer to FIG. 2. FIG. 2 is a perspective view of the chassis 1 of the conventional optical disk drive. Multiple screw bases 11 and fixed bases 10 are mounted on the chassis 1. The spindle plate 6 is screwed on the screw bases 11 of the chassis 1 by screws, and two ends of the second guide rod 3 and one end of the first guide rod 2 are disposed on the fixed bases 10 respectively. Each of the fixed base 10 further comprises a screw 7 and a spring 8, and the end of the guide rod is clamped between the screw 7 and the spring 8. The guide rod is moved upward or downward by screwing the screw 7, and the height of the end of the guide rod depends on the depth of the screw 7 screwed into the fixed base 10 disposed on the chassis 1. Therefore, in the conventional optical disk drive, the screw 7 and the spring 8 adjust the relative height between the end of the guide rod and the chassis 1. Consequently, the laser beam emitted from the optical pickup head supported on the guide rod is adjusted to be perpendicular to the data surface of the optical disk to improve the reading accuracy and efficiency of the optical pickup head 5.

The chassis 1 further comprises a mounting base 9 as shown in FIG. 1 and FIG. 2. The mounting base 9 is integrated with the chassis 1 and bended vertically to the chassis 1. An aperture is formed on the mounting base 9, and the size of the aperture is in coordination to the diameter of the end of the first guide rod 2. The mounting base 9 is used to fix one end of the first guide rod 2. Therefore, one end of the first guide rod 2 is fixed on the mounting base 9 of the chassis 1 as a standard point, and the other end of the first guide rod 2 and two ends of the second rod 3 deposed on the fixed bases 10 are adjusted relatively to the standard point by the screws 7.

However, the development of the optical storage technology is so fast that there are more and more data stored in the optical disk, and the off-center distance between the spindle motor 4 and the laser beam, therefore, plays an important role for reading the optical disk.

According to the conventional optical disk drive, the optical pickup head 5 is disposed on the first guide rod 2. Therefore the off-center distance between the spindle motor 4 and the laser beam emitted from the optical pickup head 5 is determined by the position of the first guide rod 2. Moreover, the position of the first guide rod 2 is determined by the mounting base 9.

Generally, the position of the mounting base 9 is determined at an ideal position that the off-center distance between the spindle motor 4 and the laser beam is close to be zero. So that the first guide rod 2 is at an appropriate position when the end of the first guide rod 2 is fixed on the mounting base 9 of the chassis 1.

But when assembling the spindle plate 6 on the screw bases 11 of the chassis 1, the spindle plate 6 and the chassis 1 would produce the accumulating tolerance. Owing to the accumulating tolerance, the position of the mounting base 9 on the chassis 1 is not at the ideal position, and the position of the first guide rod 2 fixed by the mounting base 9 is not at the appropriate position. Therefore the off-center distance between the spindle motor 4 and the laser beam is increased, and the reading accuracy and efficiency of the optical pickup head 5 are not good.

Therefore, the present invention is to find a way to reduce the accumulating tolerance produced by the assembling and overcome the drawbacks of the conventional optical disk drive mentioned above.

### SUMMARY OF THE INVENTION

The object of the present invention is to provide a positioning apparatus. The positioning apparatus reduces the accumulating tolerance produced by the assembling to improve the reading accuracy and efficiency of an optical pickup head.

According to the present invention, the positioning apparatus of guide rod for an optical disk drive is provided to include: at least a guide rod for supporting an optical pickup head, a chassis, and a spindle plate for supporting a spindle motor. The one end of the guide rod is fixed on the chassis and the other end is fixed on the spindle plate.

According to the preferred embodiment of the present invention, the spindle plate comprises a mounting base, and an aperture is formed on the mounting base. The size of the aperture is in coordination to the diameter of the end of the guide rod and the guide rod is fixed by the aperture on the mounting base.

According to the positioning apparatus of the present invention, the one end of the guide rod and the spindle motor are both disposed on the spindle plate so that the accumulating tolerance is reduced. By the positioning apparatus, the guide rod is positioned at an appropriate position and the off-center distance between the spindle motor and the laser beam emitted from the optical pickup head is within precision range. Therefore the reading accuracy and efficiency of the optical pickup head are improved.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a partially exploded view of internal mechanism of a conventional optical disk drive.

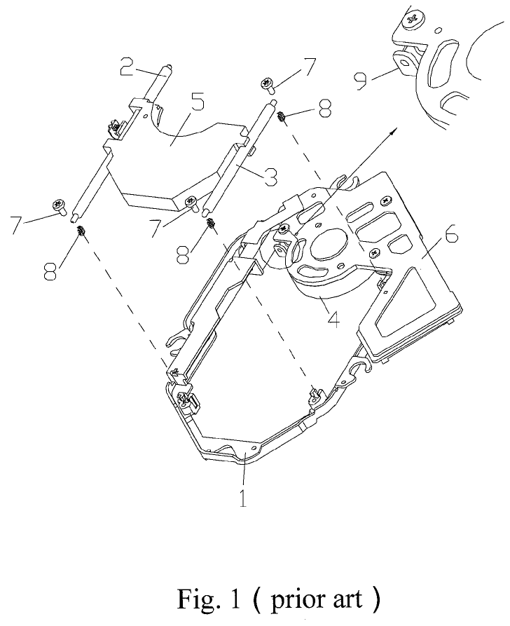

FIG. 2 is a perspective view of a chassis of the conventional optical disk drive.

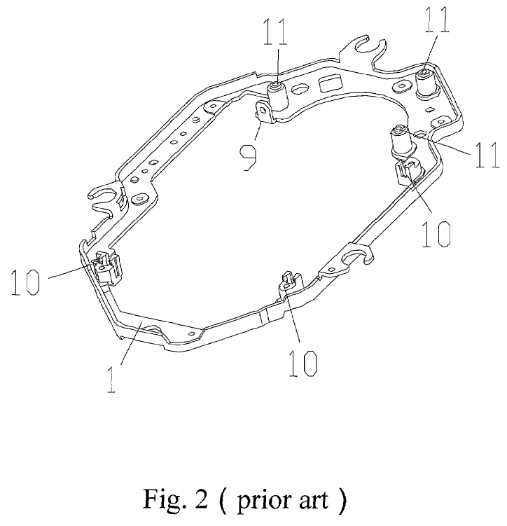

FIG. 3 is a perspective view of a positioning apparatus according to a preferred embodiment of the present invention.

FIG. 4 is a perspective view of a spindle plate shown in FIG. 3.

### DETAILED DESCRIPTIONS OF THE PREFERRED EMBODIMENT

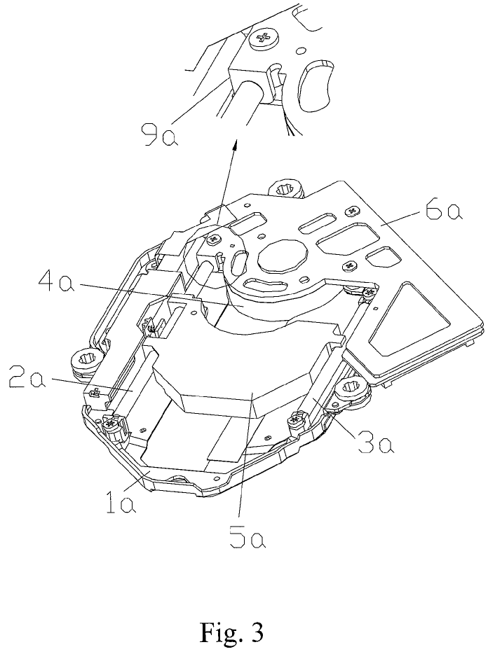

Please refer to FIG. 3. FIG. 3 is a perspective view of a positioning apparatus according to a preferred embodiment of the present invention.

The positioning apparatus according to the preferred embodiment of the present invention includes a chassis 1a, a spindle plate 6a for supporting a spindle motor 4a and a guide rod 2a for supporting an optical pickup head 5a. The spindle motor 4a is used to support and rotate an optical disk. One end of the guide rod 2a is disposed on the spindle plate 6a and the other end is disposed on the chassis 1a.

In this embodiment, the guide rod 2a is a first guide rod 2a and the positioning apparatus further comprises a second guide rod 3a. Both ends of the second guide rod 3a are disposed on the chassis 1a. The optical pickup head 5a is slidably disposed on the first guide rod 2a and the second guide rod 3a and is moved by a stepping motor mounted on the chassis 1a so as to read the optical disk.

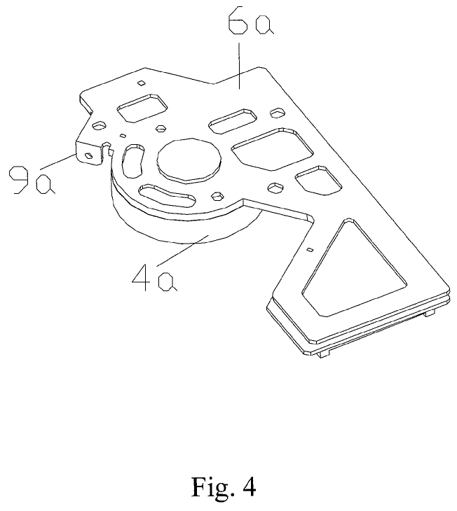

Please refer to FIG. 4. FIG. 4 is a perspective view of the spindle plate 6a of the present invention.

In this embodiment, the positioning apparatus further includes a mounting base 9a which is integrated with the spindle plate 6a and is bended vertically to the spindle plate 6a. An aperture is formed on the mounting base 9a and the size of the aperture is in coordination to the diameter of the end of the first guide rod 2a. Therefore one end of the first guide rod 2a is fixed on the aperture of the mounting base 9a on the spindle plate 6a as shown in FIG. 3.

In this embodiment, the position of the mounting base 9a is disposed at the position that the off-center distance between the spindle motor 4a and the laser beam emitted from the optical pickup head 5a is close to be zero. According to the present invention, one end of the first guide rod 2a is fixed on the mounting base 9a of the spindle plate 6a. In other words, the spindle motor 4a and the one end of the first guide rod 2a are both disposed on the spindle plate 6a. Therefore, there is no accumulating tolerance between the spindle motor 4a and the one end of the first guide rod 2a, and the off-center distance between the spindle motor 4a and the laser beam emitted from the optical pickup head 5a is within the precision range so that the reading accuracy and efficiency of the optical pickup head 5a are improved.

In summary, the positioning apparatus of guide rod for an optical disk drive according to the present invention reduces the accumulating tolerance produced by the assembling. And the off-center distance between the spindle motor and the laser beam emitted from the optical pickup head is within the precision range. By the positioning apparatus, the optical pickup head can read the optical disk more accurately and efficiently.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A positioning apparatus of guide rod for an optical disk drive comprising:
a chassis;
a spindle plate for supporting a spindle motor; and
at least a guide rod for supporting an optical pickup head;
wherein one end of the guide rod is fixed on the chassis and the other end is fixed on the spindle plate.

2. The positioning apparatus as claimed in claim 1, wherein the spindle plate comprises a mounting base, wherein the other end of the guide rod is fixed by the mounting base.

3. The positioning apparatus as claimed in claim 2, wherein an aperture is formed on the mounting base and the size of the aperture is in coordination to the diameter of the end of the guide rod.

4. The positioning apparatus as claimed in claim 2, wherein the mounting base is integrated with the spindle plate.

5. The positioning apparatus as claimed in claim 2, wherein the mounting base is bended vertically to the spindle plate.
